(19) United States
(12) Patent Application Publication
(10) Pub. No.: US 2005/0105173 A1
(43) Pub. Date: May 19, 2005

(54) Freely positionable display device for microscope data and/or image data

(76) Inventors: Michael Wagener, Goettingen (DE); Frank Bauer, Gleichen-Diemarden (DE)

Correspondence Address: Gerald H. Kiel, Esq.;REED SMITH LLP, 599 Lexington Avenue, New York, NY, 10022-7650, US

(21) Appl. No.: 10/949,598

(22) Filed: Sep. 24, 2004

(30) Foreign Application Priority Data
Sep. 26, 2003 (DE) 203 15 100.3

(51) Int. Cl. G01N 23/00

(52) U.S. Cl. 359/369

(57) ABSTRACT

A display device is provided for microscope data and/or image data which can be attached to different locations of the microscope or set up in the immediate surroundings thereof for ergonomic reasons and technical reasons relating to application. The freely positionable display device, according to the invention, for microscope data and/or image data comprises a housing with a display and a data link to the microscope. The data link is carried out by a connection line or in wireless manner. The display is swivelable in at least one direction, and the housing of the display device has devices for attaching to the microscope and/or for setting it down securely. The proposed solution offers the possibility of attaching the display device for microscope data and/or image data at optional locations of the microscope or setting it down in the area surrounding the microscope and orienting it in an ergonomic manner for optimal visual contact. The solution can be applied in many different fields of microscopy in which the observer must view the microscope data and/or image data by a display device.

### CROSS-REFERENCE TO RELATED APPLICATION

This application claims priority of German Application No. 203 15 100.3, filed Sep. 26, 2003, the complete disclosure of which is hereby incorporated by reference.

### BACKGROUND OF THE INVENTION

a) Field of the Invention

The present solution is directed to a display device for microscope data and/or image data which can be attached to different locations of the microscope or set up in the immediate surroundings thereof for ergonomic reasons and technical reasons relating to application.

b) Description of the Related Art

The microscopes known from the prior art have a large number of adjustable functions and examination modes. As a result of increasing automation, microscope functions such as the objective turret or reflector turret are usually moved by motor-actuated adjusting drive units. Due to the fact that the position of the respective components is reported to the microscope electronics in such cases, it is also possible to display the current microscope data clearly on an LCD display or, by means of software, on a computer so that the current adjustment values can always be viewed. As a rule, display devices of this kind are integrated in the microscope stand.

The laid open application DE 101 06 275, for example, describes an arrangement and a method for controlling and/or displaying microscope functions in which a display is provided at or in the vicinity of the user's eye level. In this way, the user can immediately view the current adjustments such as lamp brightness, type of objective, illumination mode, and so on, in a relaxed posture when looking into the binocular viewer and can change or correct these current settings in a simple manner using control buttons at the microscope. The display can be advantageously switched off in order to prevent glare when looking through the binocular viewer. Because of the rigid position of the display at the microscope, it can happen in certain applications that the display is at least partly concealed, for example, by manipulators or the like. Therefore, it is only with difficulty that the user can correctly read off the displayed microscope data. Incorrect or incomplete reading can also cause the user to make incorrect adjustments at the microscope. In another embodiment, the display is designed to be removable. This is advantageous in that the user can set the display off to the side, e.g., in order to make recordings of the current recording conditions.

### OBJECT AND SUMMARY OF THE INVENTION

It is the primary object of the present solution to develop a display device for microscopes which can be freely positioned at the microscope and in the area immediately surrounding it so that the displayed data and/or images are visible to the user at all times.

This object is met in a freely positionable display device for microscope data and/or image data comprising a housing having a display and a data link to a microscope. A connection line or a wireless approach being used for carrying out the data link. The display is swivelable in at least one direction. The housing of the display device having devices for attaching to the microscope and/or for setting it down in a secure manner.

The proposed solution makes it possible to attach the display device for microscope data and/or image data at desired locations of the microscope or to set it down in the surrounding area and orient it ergonomically for optimal visual contact. The solution can be applied in many different fields of microscopy in which the observer must view the microscope data and/or image data by means of a display device.

The solution will be described in the following with reference to an embodiment example.

### BRIEF DESCRIPTION OF THE DRAWINGS

In the drawings:

FIG. 1 shows the display unit attached to the microscope with the display directed straight ahead; and

FIG. 2 shows the display unit placed in the surrounding area of the microscope with tilted display.

### DESCRIPTION OF THE PREFERRED EMBODIMENTS

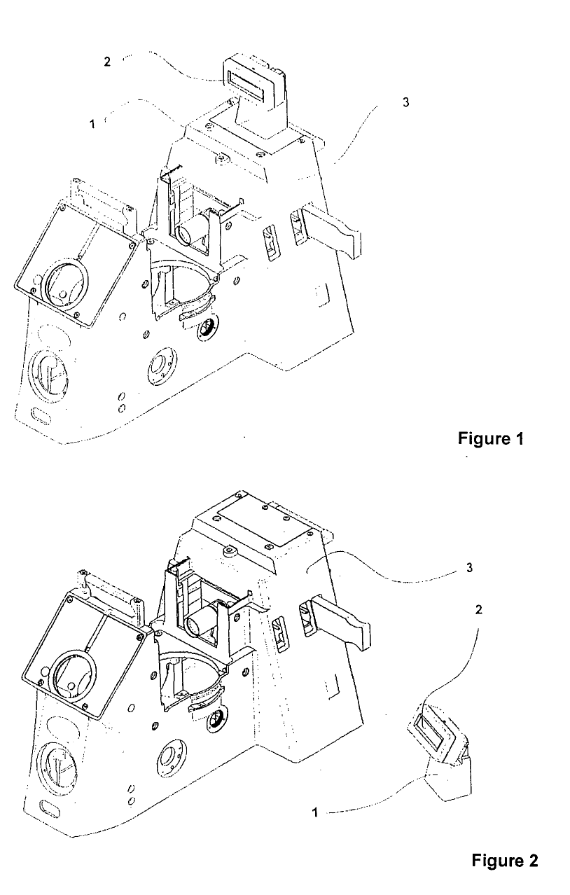

The freely positionable display device for microscope data and/or image data comprises a housing 1 with a display 2 and a data link to the microscope 3. The data link can be carried out by means of a connection line. However, a wireless connection, e.g., by means of radio waves or IR waves, is preferable. The display 2 is swivelable in at least one direction so that it can be directed in the viewing direction of the user. Devices such as magnets, suction cups, clamps or the like are provided at the housing 1 of the display device for attaching to the microscope 3 and/or for secure placement thereof. FIG. 1 shows the display unit attached to a microscope 3 with the display 2 directed straight ahead and FIG. 2 shows the display unit with tilted display 2 placed in the surrounding area of a microscope 3.

The proposed solution offers the possibility of attaching the display device for microscope data and/or image data at optional locations of the microscope or setting it down in the area surrounding the microscope and orienting it in an ergonomic manner for optimal visual contact. This is advantageous when the display device is hidden from the user's view, e.g., by samples, microscope stage, manipulators or the like, in case of special applications. In this case, the display device can be attached or set down and oriented at a more visible location for the user.

While the foregoing description and drawings represent the present invention, it will be obvious to those skilled in the art that various changes may be made therein without departing from the true spirit and scope of the present invention;

1. A freely positionable display device for microscope data and/or image data comprising:
a housing having a display and a data link to a microscope;
a connection line or a wireless approach being used for carrying out the data link;
said display being swivelable in at least one direction; and
the housing of the display device having devices for attaching to the microscope and/or for setting it down in a secure manner.

2. A display device according to claim 1, wherein magnets, suction cups, clamps or the like are provided as devices for attaching it to the microscope and/or for setting it down in a secure manner.
